(19) United States
(12) Patent Application Publication
(10) Pub. No.: US 2009/0108103 A1
(43) Pub. Date: Apr. 30, 2009

(54) Needle Valve Assembly for Spray System

(75) Inventor: Raymond A. LaMantia, Rockford, IL (US)

Correspondence Address: REINHART BOERNER VAN DEUREN P.C., 2215 PERRYGREEN WAY, ROCKFORD, IL, 61107, US

(73) Assignee: LSP Industries, Inc., Rockford, IL (US)

(21) Appl. No.: 11/929,012

(22) Filed: Oct. 30, 2007

(51) Int. Cl. B05B 1/30; B05B 7/24; B67D 5/08; F16K 21/00

(52) U.S. Cl. 239/398; 239/569; 239/71; 251/356

(57) ABSTRACT

A spray system with an improved valve assembly for various liquid spray applications is provided. The improved needle valve assembly includes a variable orifice and a fixed orifice for enhanced controllability of liquid output. The liquid output control is enhanced when a variable orifice is adjusted to regulate a liquid flow rate while a minimum flow rate is precisely maintained by a proper selection of a fixed orifice.

### FIELD OF THE INVENTION

This invention pertains generally to a liquid spray system and more particularly to a valve assembly of the spray system for liquid output control.

### BACKGROUND OF THE INVENTION

Spray systems with a spray nozzle assembly and a conventional valve assembly controlling a liquid flow rate are generally known in the prior art. The present assignee's product brochure as disclosed in the information disclosure statement describes such liquid spray systems. For example, the MeterMist model discloses a liquid spray system with a spray nozzle assembly attached to a metering body assembly including a piston pump and a valve assembly controlling liquid output. Such liquid spray system is used to apply coolant in applications like drilling, milling, tapping, stamping, or punch, or to apply lubricant in chainline or assembly applications.

In liquid spray applications, ability to maintain and control a liquid flow rate is desirable in achieving an optimal liquid coverage efficiency. The present invention relates to a liquid spray system with an improved valve assembly enhancing controllability of liquid output for applications that may have varying liquid flow rates and/or that may use different viscosity liquids.

### BRIEF SUMMARY OF THE INVENTION

The present invention provides for a spray system with an improved needle valve assembly having a variable orifice and a fixed orifice for enhanced controllability of liquid output. The liquid output control is enhanced when a variable orifice is adjusted to regulate a liquid flow rate while a minimum flow rate is precisely maintained by a proper selection of a fixed orifice.

According to one preferred embodiment, a spray system for various liquid applications includes a metering body connected to a liquid tank, a spray nozzle assembly, and a pressurized gas supply. In such system, a flow rate of liquid entering the metering body from the liquid tank is controlled by a valve assembly including a variable orifice and a fixed orifice. In an open variable orifice position, the liquid flow rate is controlled by a flow area of the variable orifice adjustable by a slidable needle valve, while a minimum liquid flow rate is maintained by a fixed orifice within the needle valve. In a closed variable orifice position, the liquid flow rate is controlled only by the size of the fixed orifice. The liquid regulated by the valve assembly is then transported into the spray nozzle assembly where the liquid is atomized by a gas stream from the pressurized gas supply forming a liquid spray.

According to one embodiment of a needle valve assembly, the needle valve has a conical valve control surface and sits in a valve body which includes an inlet and an outlet and a fluid passageway extending therebetween. The needle valve is slidable in a valve chamber toward and away from an annular valve seat arranged about the valve axis wherein a variable orifice is formed between the conical control surface and the valve seat. The needle valve also includes a fixed orifice maintaining a minimum flow rate and connecting the inlet and the outlet of the valve body in a parallel fluid circuit with the variable orifice.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a spray system with a partial cross-sectional view of a spray nozzle assembly according to the present invention;

FIG. 2 is an exploded view of an improved needle valve assembly and a piston pump assembly with a metering body according to the present invention;

FIG. 3 is a side cross-sectional view of the metering body in a closed variable orifice position;

FIG. 4 is a side cross-sectional view of the metering body in FIG. 3 in an open variable orifice position;

FIG. 5 is an exploded side cross-sectional view of a needle valve insert, a needle valve stem, adapter, and a cap dial of the needle valve assembly; and

FIG. 6 is a perspective view of the needle valve assembly.

FIG. 7 is a schematic view of an alternative embodiment of the spray system without a pump assembly.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

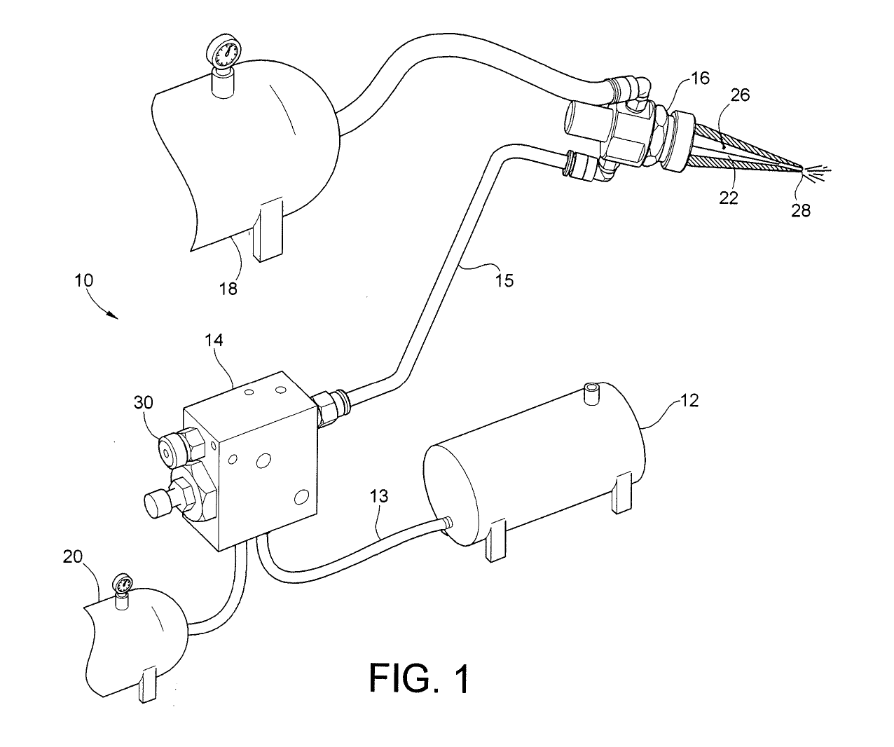

FIG. 1 illustrates a preferred embodiment of a spray system 10 with an improved needle valve assembly 30 for high air pressure spray applications with a piston triggering mechanism for liquid dispensing. Such system may be used to apply coolant or lubricant in drilling, milling, tapping, stamping and punch operations. Also, the spray system may be used for chainline lubrication or assembly applications. The spray system may also be suitable for food applications such as adding coloring to food products.

As shown in FIG. 1, the preferred embodiment of a spray system in accordance with the present invention includes a metering body 14, a spray nozzle assembly 16, a liquid tank 12, and pressurized gas supplies 18, 20. This embodiment is shown with two pressurized gas supplies 18, 20, although, a single gas supply may be used. In the spray system, a liquid is fed from the liquid tank 12 through a tube 13 which connects the liquid tank 12 and the metering body 14. Then the liquid is transported through the metering body 14 wherein a liquid flow rate is controlled by the needle valve assembly 30. The controlled amount of liquid then enters the spray nozzle assembly 16 through a tube 15 which connects the metering body 14 and the spray nozzle assembly 16 wherein the liquid is atomized by a gas stream from a pressurized gas supply 18.

The first gas supply 18 is directed through the spray nozzle assembly 16 where it atomizes a liquid such as lubricant to form a liquid spray. The second gas supply 20 in this embodiment is connected to the metering body 14 to drive a piston pump cycle, pumping a liquid from the liquid tank 12 through the metering body 14 into the spray nozzle assembly 16 where the liquid is atomized by the gas stream from the first gas supply 18, forming the liquid spray. The liquid tank 12 is connected to the metering body 14 and can either be gravity fed or with light pressure when desirable.

Referring to FIGS. 1, 3, and 4, the second pressurized gas supply 20 is connected to the metering body 14 at a gas inlet 38. The gas flow entering the metering body 14 is vented to the rear of the piston 44, moving it forward. As the piston 44 moves, a liquid from the liquid tank 12 is pumped into a piston chamber 34 through a check valve 41. The liquid in the piston chamber 34 is then force into the fluid passageway 46 leading to a valve chamber 50. When the piston 44 bottoms at the end of a pump cycle, the piston 44 is repositioned by a return spring 45 for the next pump cycle.

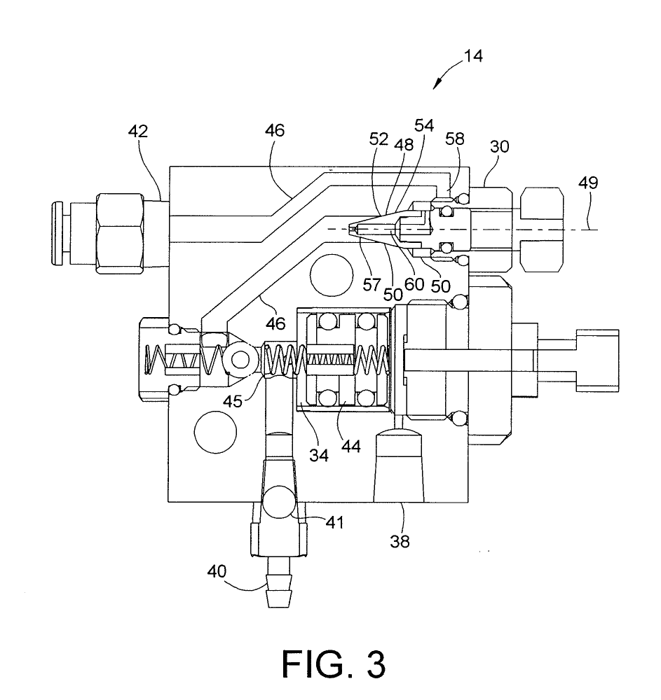

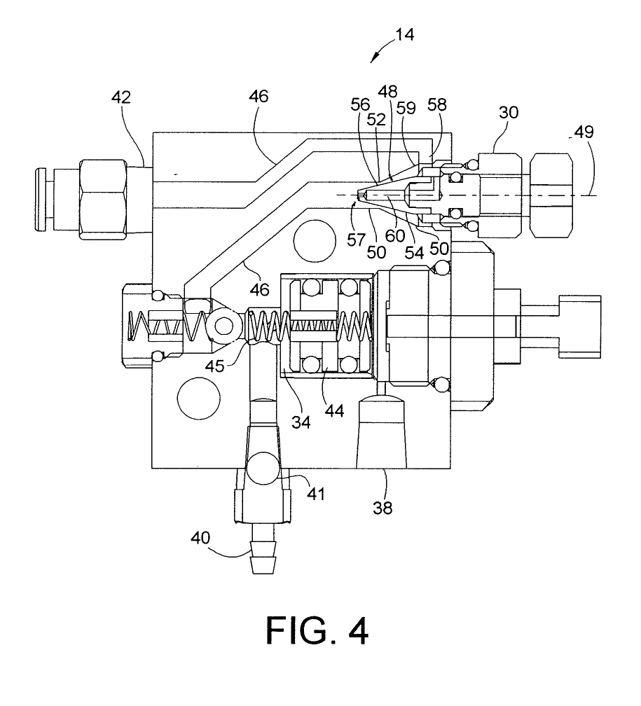

As illustrated in FIGS. 3 and 4, the metering body 14 has a fluid inlet 40 connected to the liquid tank 12 and a fluid outlet 42 connected to the spray nozzle assembly 16. A fluid passageway 46 is extended between the fluid inlet 40 and the fluid outlet 42, transporting the liquid dispensed from the liquid tank 12 through the metering body 14 and into the nozzle assembly 16. A flow rate of the liquid entering the metering body 14 is controlled by the needle valve assembly 30 with a variable orifice 56 and a fixed orifice 60.

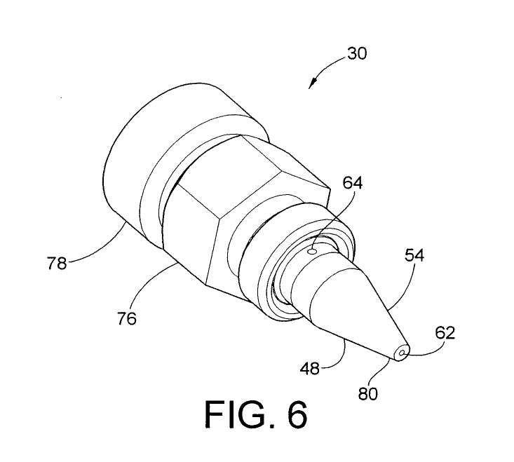

Considering the needle valve assembly 30 in more detail, with reference to FIGS. 3, 4, and 6, the needle valve 48 is generally conical cylinder in shape and has a truncated tip 80. A valve chamber 50 has an inlet 57, an outlet 58, and a fluid passageway 59 extending therebetween. The inlet 57 opens to the fluid passageway 46 connecting to the piston chamber 34, and the outlet 58 opens to the fluid passageway 46 leading to the nozzle assembly 16. The valve chamber 50 is arranged along a valve axis 49 and interposed along the fluid passageway 46 with an annular valve seat 52 arranged about the axis 49. A needle valve 48 is slidable in the valve chamber 50 toward and away from the valve seat 52. The needle valve 48 includes a conical control surface 54 wherein a variable orifice 56 is formed between the conical control surface 54 and the valve seat 52. The needle valve 48 also has a fixed orifice 60 connecting the inlet 57 and the outlet 58 in parallel fluid circuit with the variable orifice 56.

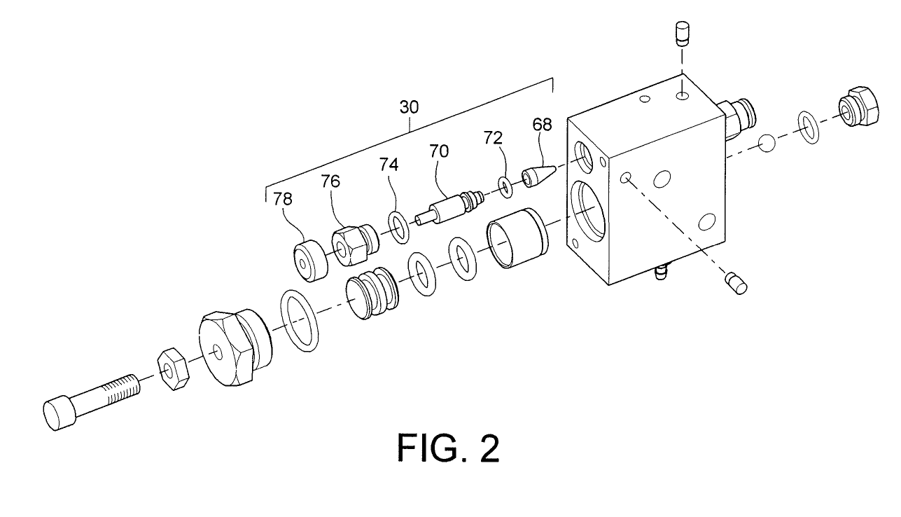

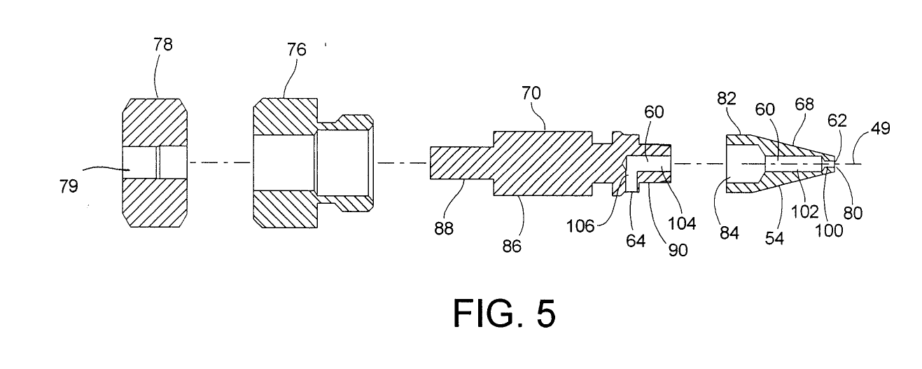

Referring to FIGS. 2 and 5, a preferred embodiment of the needle valve assembly 30 has a needle valve insert 68 connected to a needle valve stem 70 with an annular seal 72 therebetween. The other end of the valve stem 70 is connected to a cap dial 78 with an annular seal 74 and a adapter 76 therebetween. The fixed orifice 60 is preferably defined through the needle valve insert 68 and through the valve stem 70.

The needle valve insert 68 is generally conical in shape and has a cylindrical shape portion 82 and a truncated tip 80. The fixed orifice 60 is formed through the needle valve insert 68 coaxially with the valve axis 49 and includes a restricted flow area 100 with a reduced diameter and a portion of the flow passageway with a larger diameter 102. The needle valve insert 68 has a cylindrical portion of its body 82 which has a cylindrical bore extending through the cylindrical portion of its body, defining a compartment 84 in which the valve stem 70 is mounted. The valve insert 68 also has a portion of its body defining a conical control surface 54 which includes a stepped axial bore defining the fixed orifice 60. The axial bore has coaxial bore portions defining a restricted flow area 100 and an increased diameter fluid passageway 102 within the valve insert 68. The transition between bore portions 100 and 102 is tapered. The restricted flow area 100 extends to the truncated tip 80 defining a fixed orifice inlet 62. The fixed orifice inlet 62 opens to the fluid passageway 46 which is connected to the piston chamber 34.

The needle valve stem 70 is mounted in the valve insert compartment 84 completing the fixed orifice fluid circuit 60. The valve stem 70 is a solid, one-piece element which includes a cylindrical main body portion 86, a reduced diameter cylindrical portion 88, and a head portion 90 which includes axial and radial fixed orifice passageways 104, 106. The needle valve stem 70 includes an axial bore 104 with a diameter equivalent to the diameter of the valve insert passageway 102. The axial bore 104 extending from the end of head portion 90 continues through until it meets a radial bore 106. The axial passageway 104 is orthogonally connected to the radial flow passageway 106. The radial bore 106 extends through one side of the head portion 90 defining a fixed orifice outlet 64. The head portion 90 fits into the valve insert compartment 84, connecting fluid passageway 102 of the valve insert 68 with the axial passageway of the valve stem 104, thereby defining the fixed orifice 60 extending from the fixed orifice inlet 62 to the fixed orifice outlet 64. The fixed orifice outlet 64 opens to the fluid passageway 46 leading to the nozzle assembly.

The reduced diameter cylindrical portion 88 of the valve stem 70 is connected to the cap dial 78. The cap dial 78 has a cylindrical bore 79 through its body where the reduced diameter 88 of the cylindrical valve stem 70 is tightly fitted. The main body portion 86 of the valve stem 70 has threads on its outer surface. The adapter 76 is generally cylindrical shape and has a larger diameter portion with hexagonal outer surface and a reduced diameter portion. The adapter 76 is bored through with complementary threads on its inner surface which mate the threads on the valve stem, thereby enabling manual adjustment of the needle valve stem 70 together with the needle valve insert 68 by rotating the cap dial 78. For example, in one preferred embodiment of the needle valve assembly 30, turning the cap dial 78 in a clockwise direction moves the needle valve 48 toward the valve seat 52, decreasing the variable orifice gap 56, and ultimately engages the conical control surface 54 with the valve seat 52 to a closed variable orifice position. In such operation, a liquid flow rate is reduced as the variable orifice decreases until the liquid flow through the variable orifice 56 is stopped in the closed variable orifice position, while a minimum liquid flow rate is maintained by the fixed orifice 60.

The minimum flow rate of liquid in the present invention is controlled by a fixed orifice flow area 60. The controllability of the minimum flow rate is enhanced with the metering body 14 which includes multiple interchangeable needle valve assemblies 30, each with a fixed orifice of a different flow area to provide for different minimum liquid outputs. By a way of selecting a proper valve assembly 30 according to the viscosity of a liquid, a desired minimum flow rate may be obtained. Efficiency of an operation is improved when a quick changeover to a different liquid is made possible with multiple interchangeable valve assemblies 30. Alternatively, the metering body 14 may include a kit having multiple interchangeable needle valve inserts 68, each with a fixed orifice of a different flow area to provide for different minimum liquid output.

Referring back to FIGS. 1, 3, and 4, the liquid pumped into the metering body 14 is transported through the fluid passageway 46 entering the valve chamber 50 from the valve inlet 57. The liquid then flows through the valve chamber in two ways, the variable orifice 56 and the fixed orifice 60. The flow rate of the liquid passing through the variable orifice is controlled by the flow area form between the valve seat 52 and the conical valve control surface 54 which is manually adjusted by rotating the cap dial 78. The liquid flow rate of the fixed orifice 60 is controlled by the size of the fixed orifice selected from the interchangeable valve assemblies 30. This dual flow rate control mechanism enhances controllability of the liquid output in the present invention.

Once the regulated amount of liquid passes the valve assembly 30, the liquid is transported through the liquid passageway 46 exiting out of the fluid outlet 42 of the metering body 14 and enters a fluid passageway 26 of the spray nozzle assembly 16. A gas stream from the first pressurized gas supply 18 flows into the spray nozzle assembly 16 and passes through a gas passageway 22, expelling at the nozzle tip 28. The exiting gas stream creates a venturi effect placing a suction on the fluid passageway 26 at the tip of the nozzle 28, thereby expelling the liquid into the gas stream where the gas stream atomizes the liquid, forming a liquid spray output.

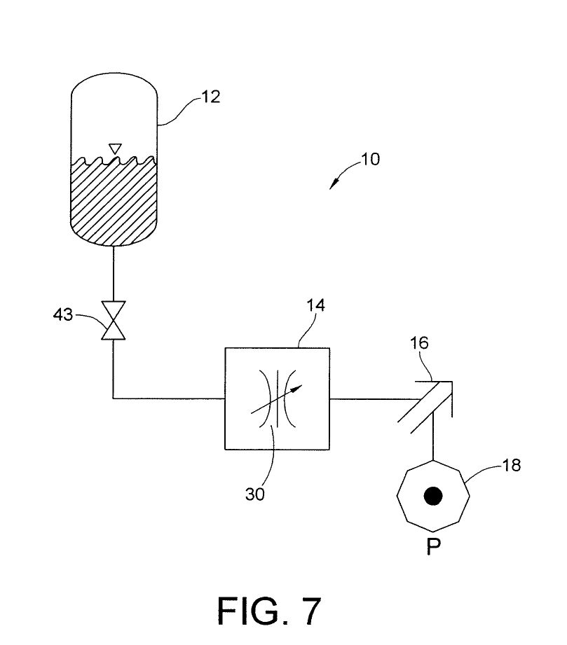

FIG. 7 illustrates a schematic drawing of an alternative embodiment. In this embodiment the liquid tank 12 is connected to the metering body 14 which does not include a pump. A liquid is either gravity fed or with a light pressure from the liquid tank 12 to the metering body 14. The liquid normally flows into the metering body 14 continuously, but may be stopped by a shut-off valve 43. Although the shut-off valve 43 is shown between the liquid tank 12 and the metering body 14 in FIG. 7, the shut-off valve 43 may be placed in other locations such as in the metering body 14, between the metering body 14 and the spray nozzle assembly 16, or in the spray nozzle assembly 16.

In a normal operation of this embodiment, the liquid enters the metering body 14, continuously in a low volume, and is controlled by a needle valve assembly 30 with a variable orifice 56 and a fixed orifice 60. In low liquid volume applications using low viscosity liquids, the variable orifice 56 remains closed, leaving only the fixed orifice 60 for the liquid output control. For applications with higher viscosity liquids or higher liquid volumes, the variable orifice 56 is opened to obtain a desired liquid flow rate.

The needle valve assembly 30 in the alternative embodiment is same as the needle valve assembly 30 described above in the first preferred embodiment. In this spray system 10, the needle valve assembly 30 is selected according to the liquid viscosity in a particular application. For example, a needle valve assembly 30 with a smaller fixed orifice flow area is selected for lighter liquids with a low viscosity or where a low liquid flow rate is desired. In such applications, the variable orifice 56 remains in the closed position to stop liquid flowing through the variable orifice 56. For applications involving heavier liquids with a higher viscosity, the variable orifice 56 is adjusted manually with the cap dial 78 until a desired liquid flow rate is obtained. Thus, controllability of liquids with different viscosities is improved through use of both the variable orifice 56 and the fixed orifice 60.

Moreover, the improved needle valve assembly allows for expanded utilization of a spray system by enabling applications of liquids with different viscosities simply by exchanging the needle valve assembly 30 and adjusting the variable orifice 56. This embodiment of the spray system 10 may be used for paint spray applications, lubricant applications for stamping, punch, assembly operations, and chainline lubrication. The spray system may also be used for some food applications such as coating baking trays.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A spray system for spraying a liquid, comprising:
a liquid tank;
a metering body having a fluid inlet connected to the liquid tank and a fluid outlet;
a spray nozzle assembly connect to the fluid outlet for receipt of the liquid;
a first gas passageway adapted for connection to a pressurized gas supply, the first gas passageway communicating with and through the spray nozzle wherein during operation pressurized gas is adapted to atomize the liquid delivered to the spray nozzle;
a valve between the fluid inlet and the fluid outlet providing a variable orifice adapted to adjust liquid flow rate; and
a fixed orifice between the fluid inlet and the fluid outlet adapted to control flow rate at a low output of liquid delivery.

2. The spray system of claim 1, further comprising:
the fluid passageway extending between the fluid inlet and the fluid outlet;
the valve slidable in a valve chamber arranged along a valve axis being interposed along the fluid passageway with an annular valve seat being arranged about the valve axis; and
the valve having a conical control surface wherein the variable orifice is formed between the conical control surface and the valve seat, and the fixed orifice through the valve.

3. The spray system of claim 2 wherein the valve is slidable toward the valve seat closing the variable orifice in a closed valve position by engagement between the conical control surface and the valve seat;
the valve in the closed valve position closing the fluid passageway through the variable orifice; and
the valve having the fixed orifice maintaining a minimum liquid output in the closed valve position.

4. The spray system of claim 3 wherein the valve is sliable away from the valve seat to an open position, thereby opening the variable orifice to form a gap between the conical control surface and the valve seat;
the variable orifice gap between the conical control surface and the valve seat defining a variable flow area through the variable orifice for control of the flow rate of the liquid.

5. The spray system of claim 4 wherein the valve is assembled with a cap dial adapted for manual adjustment of the variable orifice;
the cap dial be manually actuated to control the variable orifice gap by sliding the valve toward and away from the valve seat.

6. The spray system of claim 4 wherein the valve is a needle valve, and the metering body including a kit having multiple interchangeable needle valve inserts, each needle valve insert having a fixed orifice of a different flow area to provide for different minimum liquid outputs;
the flow area of the fixed orifice controlling minimum flow rate of the liquid.

7. The spray system of claim 1, further comprising:
a fluid passageway extending between the fluid inlet and the fluid outlet wherein a liquid flows in from the liquid tank continuously at a low flow rate;
the valve slidable in a valve chamber arranged along a valve axis being interposed along the fluid passageway with an annular valve seat being arranged about the valve axis; and
the valve having a conical control surface wherein the variable orifice is formed between the conical control surface and the valve seat, and the fixed orifice through the valve.

8. The spray system of claim 7 wherein valve is slidable toward the valve seat closing the variable orifice to a closed valve position by engagement between the conical control surface and the valve seat;
the fixed orifice maintaining a consistent low flow rate liquid output through the fixed orifice of the valve;

9. The spray system of claim 8 wherein the valve is a needle valve and the metering body including multiple interchangeable needle valve assemblies, each needle valve assembly having a fixed orifice of a different flow area to provide for different minimum liquid outputs;
the flow area of the fixed orifice controlling minimum flow rate of the liquid; and
the needle valve assembly selected for a desired flow rate of a liquid with the variable orifice in the closed position.

10. The spray system of claim 8 wherein the valve is slidable away from the valve seat, thereby opening the variable orifice and forming a gap between the conical control surface and the valve seat;
the variable orifice gap adjusted according to a liquid viscosity and a desired flow rate of the liquid;
the variable orifice adjusted to increase the variable orifice gap thereby increasing the flow area for higher viscosity liquids; and
the variable orifice manually adjustable by a cap dial adapted for controlling the sliding action of the valve.

11. The spray system of claim 1 further comprising:
a needle valve insert having a fixed orifice and defining the conical control surface;
a needle valve stem connected to the needle valve insert;
an annular seal between the needle valve insert and the needle valve stem;
a cap dial for manual adjustment of the variable orifice;
an adapter connecting the needle valve stem and the cap dial; and
an annular seal between the adapter and the needle valve stem.

12. The spray system of claim 11 having the valve insert with an end tip truncating the conical control surface;
an inlet of the fixed orifice defined by an opening at the truncated tip;
a flow passageway of the fixed orifice formed through the needle valve insert coaxially with the valve axis; and
the flow passageway extending from the fixed orifice inlet with a restricted flow area, then continuing with an increased flow area.

13. A needle valve assembly comprising:
a valve body having an inlet and an outlet and a fluid passageway extending therebetween, a valve chamber arranged along a valve axis being interposed along the fluid passageway with an annular valve seat being arranged about the valve axis;
a needle valve slidable in the valve chamber toward and away from the valve seat, the needle valve having a conical control surface wherein a variable orifice is formed between the conical control surface and the valve seat; and
a fixed orifice formed through the needle valve, the fixed orifice connecting the inlet and the outlet in parallel fluid circuit with the variable orifice.

14. The needle valve assembly of claim 13 further comprising:
a needle valve insert having a fixed orifice and defining the conical control surface;
a needle valve stem connected to the needle valve insert;
an annular seal between the needle valve insert and the needle valve stem;
a cap dial for manual adjustment of the variable orifice;
an adapter connecting the needle valve stem and the cap dial; and
an annular seal between the adapter and the needle valve stem.

15. The needle valve assembly of claim 14 wherein the needle valve insert has an end tip truncating the conical control surface;
an inlet of the fixed orifice defined by an opening at the truncated tip;
a flow passageway of the fixed orifice formed through the needle valve insert coaxially with the valve axis; and
the flow passageway extending from the fixed orifice inlet with a restricted flow area, then continuing with an increased flow area.

16. The needle valve assembly of claim 15 including an axial flow passageway of the fixed orifice formed coaxially with the axis;
the axial passageway orthogonally connected to a radial flow passageway extending to an outlet of the fixed orifice; and
the axial flow passageway of the needle valve stem communicating with the flow passageway of the needle valve insert completing the fixed orifice flow passageway connecting the inlet and outlet of the fixed orifice.

17. The needle valve assembly of claim 14 wherein the needle valve is assembled with a cap dial adapted for manual adjustment of the variable orifice;
the cap dial threaded and connected to the need valve stem through the adapter receiving the cap dial threads;
the cap dial controlling the sliding motion of the needle valve insert attached to the needle valve stem; and
the sliding motion controlled by the cap dial changing the variable orifice gap between the conical control surface of the needle valve insert and the valve seat.

18. The needle valve assembly of claim 14 wherein there are multiple interchangeable needle valve assemblies, each needle valve assembly having a fixed orifice of a different flow area;
the flow area of the fixed orifice controlling minimum flow rate of the liquid; and
the needle valve assembly is selected for a desired liquid flow rate.

19. The needle valve assembly of claim 14 including multiple interchangeable needle valve inserts, each needle valve insert having a fixed orifice of a different flow area;
the flow area of the fixed orifice controlling minimum flow rate of the liquid; and
the needle valve insert is selected for a desired liquid flow rate.
